(19) United States
(12) Patent Application Publication
(10) Pub. No.: US 2008/0160189 A1
(43) Pub. Date: Jul. 3, 2008

(54) Method for Manufacturing Zeolite Membrane

(75) Inventor: Anupam Mitra, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BUSSAN NANOTECH RESEARCH INSTITUTE, INC., Tokyo (JP)

(21) Appl. No.: 11/720,603

(22) PCT Filed: Dec. 1, 2004
(86) PCT No.: PCT/JP04/18232

§ 371 Date: Sep. 10, 2007

(51) Int. Cl. B05D 1/36

(52) U.S. Cl. 427/201

(57) ABSTRACT

There is provided a method for the production of dense crystalline zeolite membrane on a porous substrate which performs flux and separation capability in balance. The method comprises coating the surface of the porous substrate with a first powder, coating the first powder-coated surface of the porous substrate with a second powder, and contacting the first powder- and second powder-coated porous substrate with a precursor medium for the crystalline zeolite in order to carry out hydrothermal synthesis of the zeolite, wherein the first powder is a powder which renders substantially no aid to the growth of the crystalline zeolite membrane, and wherein the second powder is a crystalline zeolite powder which promotes the growth of the crystalline zeolite membrane.

### TECHNICAL FIELD

This invention relates to a zeolite membrane and method for manufacturing thereof, particularly, to a zeolite membrane which is supported on a porous substrate and has a dense structure while giving high flux, and method for manufacturing thereof.

### BACKGROUND ART

Structure and properties of zeolites are well described in “ZEOLITE MOLECULAR SIEVES”, Donald W. Breck, John Wiley & Sons, New York, 1974 (The related parts of this literature are incorporated herein by reference.).

Zeolites are used for their separation property that is based on selective adsorption or molecular sieving, and for their ion exchange and catalytic properties.

U.S. Pat. No. 4,699,892, which description is incorporated herein by reference, describes zeolite membranes and various possible applications of them. Various applications of zeolite membranes and their production method have also been cited by M. Noack et. al., in “Chemical Engineering and Technology, Volume 3, 2002, page 221”, and in the references cited therein (The related parts of these literatures are incorporated herein by reference.).

Supported zeolite membranes are normally synthesized by placing the substrate in a precursor solution of zeolite synthesis followed by hydrothermal treatment at an optimum set of condition of temperature, pressure and time.

U.S. Pat. No. 4,800,187, US patent application publications 2003/0084786 A1 and 2004/0058799 A1, and JP-60-32610-A, disclose fabrication of zeolite membrane by the same method.

Coating of the substrate with zeolite powder, prior to the hydrothermal treatment, is a common practice in the present art to facilitate formation of zeolite membrane by enhancing the crystallization of zeolite, on the substrate surface compared to that in the bulk of the precursor solution. JP-2004-82008-A, JP-9-313903-A and JP-10-36114-A, disclose fabrication of zeolite membrane by hydrothermally treating a porous substrate that is coated with zeolite particles of various types.

Substrates are used to provide mechanical strength to the membrane as the non-supported zeolite film is brittle and has extremely poor mechanical strength that limits use and fabrication of non-supported zeolite film of large surface area. Use of porous substrates of high mechanical strength overcomes such problem, however, unlike non-supported zeolite film, effective permeating area of supported zeolite membrane, that is, the area through which the permeating species flows out of the zeolite membrane, is only a fraction of the total exposed surface area of the membrane, that is, the area through which the permeating species flows in the zeolite membrane, as the solid and nonporous part of the substrate blocks the pores of a major part of the supported zeolite membrane, in the substrate-zeolite membrane interface.

Thus, given that the thickness and exposed surface area is same, total flow of species through a non-supported continuous zeolite film is expected to be higher than that of supported continuous zeolite membrane. The relative decrease in total flow through a supported zeolite membrane would be dependent on, other than the nature of the permeating species and the mechanism of permeation, the pore size and porosity of the substrate, the thickness of the zeolite-substrate composite layer. Higher the pore size and porosity of the substrate and lower the thickness of the zeolite-substrate composite layer, lower the relative decrease in total flow.

Zeolite-substrate composite layer is formed provided zeolites are crystallized in the pores of the substrate and thus produces a continuous layer that is nearly free from non-zeolitic pores. Commercially available porous substrates mostly posses a pore size distribution, rather than unique pore size. Passage of species from one side of the substrate to the other is controlled by the so called ‘average pore size’ of the substrate. Pore mouths with the size of ‘average pore size’, not necessarily, exist on the outermost surface of the substrate or, in other words, at the substrate-external medium interface, and often distributed over a certain depth of several tens of microns, from the outermost surface. Pores, those are bigger than that with average pore size of the substrates, often exist on outermost surface of the substrate. Thus, unless otherwise protected, the zeolite powder, those are smaller in size than that of pore mouth on the outermost surface of the substrate, penetrate several tens of microns dip inside the substrate, during coating. The extent of penetration depends on the porosity and pore size distribution of the substrate, particle size of the zeolites in the slurry used for the coating and method of the coating. During the successive hydrothermal treatment, in a suitable precursor solution, zeolite particles inside the substrate grow at the same rate as those on the surface of the substrate resulting in a formation of zeolite-substrate composite membrane of several tens of microns of thickness. Formation of such a composite membrane, if continuous at the same time, is detrimental to the total flow of molecules per unit time per unit surface area of the membrane as the fraction of the total surface area of the membrane, that is occupied by the accessible pore-openings, is lower for a zeolite-substrate composite membrane than that of pure zeolite film. Blocking the pores of the substrate with polymers, or the use of substrate with the pore size that is much smaller than that of zeolite particles of the slurry used for coating, can eliminate penetration of zeolite particles inside the substrate, during the coating. Removal of polymer, by high temperature baking, prior to hydrothermal treatment, provides empty substrate pores free from zeolite particles. However, such methods cannot eliminate penetration of dissolved species from the coated-zeolite particles during the hydrothermal treatment and such dissolved species are capable of promoting formation of zeolite-substrate composite membrane. On the other hand, blocking of the substrate pores by amorphous silica is also capable of eliminating penetration of zeolite particles however, silica, that is a precursor for the synthesis of all kind of zeolites, fast dissolves in the alkaline medium and possibly provides unblocked substrate in the early stage of the hydrothermal treatment resulting in the formation of zeolite-substrate composite membrane. Further, dissolution of silica alters the composition of the precursor solution in the vicinity of the membrane and changes the kinetics of crystallization, during the hydrothermal treatment.

### DISCLOSURE OF INVENTION

Therefore, this invention aims to provide a new zeolite membrane which is able to eliminate the problems associated with the prior art and method for manufacturing thereof. This invention also aims to a zeolite membrane a zeolite membrane which is supported on a porous substrate and has a dense structure while giving high flux, and method for manufacturing thereof. This invention further aims to provide a simple yet effective method for the production of high flux, zeolite membrane on porous substrate.

To solve the above mentioned problems, a method for the production of crystalline zeolite membrane on a porous substrate according to the present invention is characterized by the steps of coating the surface of the porous substrate with a first powder, coating the first powder-coated surface of the porous substrate with a second powder, and contacting the first powder- and second powder-coated porous substrate with a precursor medium for the crystalline zeolite in order to carry out hydrothermal synthesis of the zeolite, wherein the first powder is a powder which renders substantially no aid to the growth of the crystalline zeolite membrane, and wherein the second powder is a crystalline zeolite powder which promotes the growth of the crystalline zeolite membrane.

According to the present invention, by coating the first powder to the surface of the porous substrate, it is possible to reduce apparent pore diameter of the substrate substantially, and thus to prohibit the second powder which functions as seed crystals for the growing zeolite membrane from being embedded deeply into the interior of the pore of the substrate. Therefore, the growth of zeolite membrane is restricted only at the outer surface side of the substrate, and which gives an amply thin zeolite membrane in the substrate, enjoying an enhanced separation capability. Further, since the first powder does not contribute to the growth of the crystalline zeolite membrane, the particles of the first powder act as a mask at the interior side of the porous substrate. Thus, the thickness of the zeolite membrane which may be formed into the pores of substrate becomes still lower. Therefore, as the total thickness of the zeolite membrane to be obtained an adequately thin measurement is also obtained. Then, the permeable resistance of a substance passing through the membrane can be decreased, so that the high performance in the separation procedure can be expected. In addition, since the zeolite particles as the second powder are located at the outer surface of the substrate, a dense zeolite crystalline phase is grown onto the outer surface of the substrate, and by which a preferable high selectivity can be realized on the separation, with inhibiting the passage of the inherently non-permeable component.

The present invention also provides the method for the production of crystalline zeolite membrane on a porous substrate, wherein the first powder is a crystalline zeolite powder which renders substantially no aid to the growth of the crystalline zeolite membrane.

The present invention further provides the method for the production of crystalline zeolite membrane on a porous substrate, wherein the crystalline zeolite membrane to be manufactured is a member selected from the group consisting of FAU, ZSM-5, BEA, LTA, LTL, KFI, RHO, MOR and FER.

The present invention further provides the method for the production of crystalline zeolite membrane on a porous substrate, wherein the crystalline zeolite powder as the second powder has a similar framework type to that of the crystalline zeolite membrane to be manufactured.

The present invention still more provides the method for the production of crystalline zeolite membrane on a porous substrate, wherein the first powder is USY, and the second powder is NaY, when the crystalline zeolite membrane is of X or Y type FAU.

To solve the above mentioned problems, a crystalline zeolite membrane on a porous substrate according to the present invention is characterized by the fact that the membrane is manufactured by the steps of coating the surface of the porous substrate with a first powder, coating the first powder-coated surface of the porous substrate with a second powder, and contacting the first powder- and second powder-coated porous substrate with a precursor medium for the crystalline zeolite in order to carry out hydrothermal synthesis of the zeolite, wherein the first powder is a powder which renders substantially no aid to the growth of the crystalline zeolite membrane, and wherein the second powder is a crystalline zeolite powder which promotes the growth of the crystalline zeolite membrane.

### BRIEF DESCRIPTION OF THE DRAWINGS

FIG. 1 is a chart showing particle size distribution of the zeolite particles used for the coating, in Example 1;

FIG. 2 is a chart showing the X-ray diffraction pattern of the zeolite membrane produced in Example 1;

FIG. 3 is a scanning electron photomicrograph showing the surface of the zeolite membrane produced in Example 1, at a magnification of 4000 times;

FIG. 4 is a scanning electron photomicrograph showing the cross section of the zeolite membrane produced in Example 1, at a magnification of 8000 times;

FIG. 5 is a chart showing the X-ray diffraction spectra of the crystallization products produced, at various different crystallization time, in Comparison Examples 1 and 2;

FIG. 6 is a chart showing particle size distribution of the NaY zeolite particles used for the coating of second layer, in Example 2;

FIG. 7 is a scanning electron photomicrograph showing the cross section of the zeolite membrane produced in Comparison Example 3, using a slurry of 0.5 wt % of NaY in 99.5 wt % of water, at a magnification of 3500 times;

FIG. 8 is a scanning electron photomicrograph showing the cross section of the zeolite membrane produced in Example 1, at a magnification of 3500 times;

FIG. 9 is a scanning electron photomicrograph showing the cross section of the zeolite membrane produced in Example 2, at a magnification of 3500 times;

FIG. 10 is a chart showing particle size distribution of the USY zeolite particles used for the coating of first layer, in Example 4;

FIG. 11 is a scanning electron photomicrograph showing the surface of the zeolite membrane produced in Example 5, at a magnification of 3000 times;

FIG. 12 is a scanning electron photomicrograph showing the cross section of the zeolite membrane produced in Example 5, at a magnification of 10000 times;

FIG. 13 is a chart showing the X-ray diffraction pattern of the zeolite membrane produced in Example 6;

FIG. 14 is a scanning electron photomicrograph showing the cross section of the zeolite membrane produced in Example 6, at a magnification of 3500 times; and

FIG. 15 is a chart showing the X-ray diffraction spectra of the crystallization products produced, at various different crystallization time, in Comparison Examples 4 and 5.

### BEST MODE FOR CARRYING OUT THE INVENTION

Now, the present invention will be described in detail with reference to some embodiments which are non-restrictive ones, and disclosed only for the purpose of facilitating the illustration and understanding of the present invention.

The present invention provides a method for the fabrication of zeolite membrane, on the surface of a porous substrate.

The production method according to the present invention may provide production of zeolite membrane only on top of the porous substrate and elimination of zeolite/substrate composite-membrane formation. The present invention includes, but not restricted to the zeolite membranes of the type FAU, ZSM-5, BEA, LTA, LTL, KFI, RHO, MOR and FER, particularly FAU.

The production method comprises coating the substrate with two layers of particles, i.e., first and second powder, contacting the first powder- and second powder-coated porous substrate with a precursor medium for the crystalline zeolite, and carrying out hydrothermal treatment under a suitable set of condition.

In general, the method utilizes a porous substrate having high porosity and large pore size. The substrate to be used may be made of a ceramic of a general oxide such as alumina, zirconia, titania, silica, or a compound oxide such as glass, silicazirconia, silicatitania, alumina-silica or a substrate made of a metal such as iron, stainless steel, copper, aluminum, and tantalum. Particularly, the substrate is made of alumina.

The size and shape of the substrate may be, but not restricted to, about 10 to 200 cm, and tubular, respectively.

The porosity of the substrate may be, but not restricted to, about 20 to 60%.

The mean pore size of the substrate may be, but not restricted to, about 0.1 to 2.0 μm, preferably, 0.5 to 1.0 μm.

Next, the first powder is a powder which renders substantially no aid to the growth of the crystalline zeolite. When coating the first powder to the substrate, in advance of coating the second powder, the first powder coated functions as a protector for the inner layer of the porous substrate during hydrothermal treatment in order to prevent formation of dense zeolite/substrate composite-membrane.

Although the kind of first powder is not limited as far as it renders substantially no aid to the growth of the crystalline zeolite membrane to be produced, crystalline zeolite powder which renders substantially no aid to the growth of the crystalline zeolite membrane is preferable. Because, the crystalline zeolite particles may be incorporated in the obtained structure without loss of physical and chemical stability, mechanical strength, etc., although the crystalline zeolite particles of the first coating layer do not form said zeolite membrane by itself, under the selected set of conditions of the hydrothermal treatment.

As the first powder, for instance, mesoporous inorganic materials may be also utilized other than the crystalline zeolite mentioned above.

Type of the zeolite for the above mentioned first powder coating layer is, preferably, chosen such that the zeolite of the first powder coating layer has a closely related framework type to that of the zeolite of which the membrane should be produced.

Type of the zeolite for the above mentioned first powder coating layer is chosen such that the dissolution of the said zeolite produces fragments that can be directly consumed for the growth of the zeolite of which the membrane should be produced, and therefore, dissolution of the zeolite from the first powder coating layer does not alter the crystallization kinetics for the growth of the said zeolite of which the membrane should be produced. Thus, the type of the zeolite for the above mentioned first powder coating layer is chosen such that this zeolite can act as a source of precursors during the growth of the zeolite membrane to be produced. Type of the zeolite for the above mentioned coating is chosen such that no intergrowth occurs in between the zeolite particles of the first powder coating layer and the membrane to be produced, if the former is remained as non-dissolved state under the selected set of conditions of the hydrothermal treatment.

Examples of such zeolite includes, USY for the synthesis of FAU (X and Y) zeolite membrane; USY or FAU for the synthesis of LTA zeolite membrane; Silicalite, MOR, FER for the synthesis of ZSM-5 membrane; Silicalite, MOR, ZSM-5 for the synthesis of FER membrane; Silicalite, ZSM-5, FER for the synthesis of MOR membrane; pure silica BEA for the synthesis of Al containing BEA membrane; LTL for the synthesis of KFI membrane or vice versa; pure silica FER for the synthesis of Silicalite or vice versa; MEL for the synthesis of Silicalite or vice versa, particularly, USY for the synthesis of FAU (X and Y) zeolite membrane.

The first powder, typically, the zeolite particles are preferably coated, but not restricted to the outer surface of the substrate tube.

The diameter of the first powder is not particularly limited, and may be varied depending on the structure of the substrate to be used, particularly, pore diameter of the substrate, the kind of the first powder itself, etc. In a preferable embodiment, however, the mean diameter of the first powder is similar in size to that of the average pore size of the substrate. When satisfying such condition, to mask the large pores of the substrate can be attained conveniently. Further, it is preferable that the diameter distribution of the first powder is relatively narrow.

The first powder may be applied to the substrate as a slurry form, preferably, an aqueous slurry form.

The first powder coating layer formed on the surface of the substrate may be dried preferably in advance of the application of the second powder as mentioned below. However, it is also possible to apply the second powder to the first powder coating layer in wet condition.

The second powder with which the first powder-coated substrate coated is then coated in the production method according to the present invention is a crystalline zeolite powder which promotes the growth of the crystalline zeolite membrane to be obtained.

In a preferred embodiment, type of the zeolite for the above mentioned second powder coating layer may be chosen such that the zeolite of the second powder coating layer has a similar framework type to that of the zeolite of which the membrane should be produced.

The zeolite powder of the second powder coating layer may be of the similar framework type to that of the zeolite of which the membrane should be produced, and when the first and second powder coated substrate is subjected to the hydrothermal treatment in a selected set of conditions, the zeolite particles in the second coating layer grow preferentially to that of the zeolite particles of the first coating layer.

In this embodiment, the framework type of the crystalline zeolite powder as the second powder is similar to, but not necessarily to be the entirely same with, that of the zeolite of which the membrane should be produced. In this case, the framework type of which the membrane should be produced is decided by depending on the composition of the precursor medium for the crystalline zeolite. Therefore, when it is desired to produce various types of zeolite membrane on a mass production line, it is possible to adopt a strategy of using a common seed crystal, i. e., second powder, and controlling the type of zeolite to be manufactured by varied compositions of the precursor medium.

Examples of such zeolite as the second powder include, NaY for the synthesis of FAU (X and Y) zeolite membrane; NaX for the synthesis of FAU (X) zeolite membrane; LTA for the synthesis of LTA zeolite membrane; Silicalite for the synthesis of Silicalite membrane; ZSM-5 for the synthesis of ZSM-5 membrane; FER for the synthesis of FER membrane; MOR for the synthesis of MOR membrane; Al containing BEA for the synthesis of Al containing BEA membrane; KFI for the synthesis of KFI membrane; MEL for the synthesis of MEL membrane, LTL for the synthesis of LTL membrane; particularly, NaY for the synthesis of FAU (X and Y) zeolite membrane.

The diameter of the second powder is not particularly limited, and may be varied depending on the characteristics of the zeolite membrane to be manufactured, the pore diameter of the substrate, the diameter of the first powder, and the kind of the second powder itself, etc. In a preferable embodiment, however, the mean diameter of the second powder is smaller than the average pore size of the substrate. When satisfying such condition, to form a dense continuous and thin membrane can be attained conveniently. Further, it is preferable that the diameter distribution of the first powder is relatively narrow.

The second powder may be applied to the first powder coated substrate as a slurry form, preferably, an aqueous slurry form.

In the present invention, the first powder- and second powder-coated substrate is then exposed to the precursor medium of zeolite synthesis.

The precursor medium includes framework constituent atoms and ions in a ratio such that it favors formation of a zeolite that has similar framework type to that of the membrane to be produced. The precursor favors preferential growth of the layer of coated second powder, and therefore, zeolite particles of the said layer is active in growth and, thus, act as seeds; while particles of the first layer has negligible growth and, thus, inert in growth, wherein the particles of the inert first layer act as a mask to prevent formation of dense zeolite/substrate composite-membrane.

The condition of the hydrothermal synthesis of the zeolite to be manufactured is not particularly limited as far as the intended crystalline pure zeolite membrane is synthesized and it may be varied depending on the types of the zeolites used, diameters of the first and second powder, etc.

The removal of inert first layer is not required after the membrane synthesis. The inert first layer may provide precursors for the growth of the continuous zeolite membrane.

The precursor medium may be provided from both sides of the first and second layers to obtain a dense membrane.

In an embodiment of the present invention, there is further provided principle for selecting two different zeolites for the above mentioned two layers of zeolite coating, wherein those are capable of promoting crystallization of the same zeolite at different rate under similar set of conditions except that the surface properties and composition of the two types of zeolite are different, and the method for the comparison of the rate of crystallization. The principle is based on a perception that the reactivity of the zeolite particles is dependent on the surface properties that is different for particles of different surface composition.

In another embodiment of the present invention, there is further provided method for concentrating small zeolite particles in a narrow thickness, during coating over a porous substrate that comprises; masking the large pores of the substrate, first, with the zeolite particles those are similar in size to that of the average pore size of the substrate, and therefore, reducing effective pore size of the substrate and subsequently, coating a second layer of zeolite particles those are much smaller than the average pore size of the substrate. Although, growth rate is independent of the particle size [R. W. Thompson, in H. G. Karge and J. Wietkamp Edited “MOLECULAR SIEVES, Science and Technology, Volume 1, SYNTHESIS”, Springer, Berlin, Germany, 1998., page 20], a less porous thin layer of small particles might be effective in forming a dense continuous and thin membrane in a shorter crystallization time as compared to that with a more porous thick layer of big particles of similar amount, as the overall growth on a two dimensional plane is higher and faster in case of a less porous thin layer of small particles than that of more porous thick layer of big particles provided both layers contain similar amount of zeolite particles. The related parts of this R. W. Thompson's literature are incorporated herein by reference.

In still another embodiment of the present invention, there is further provided method for optimizing conditions for hydrothermal treatment that comprises; selecting a composition for the precursor medium such that the medium favors formation of product with probable Si/Al ratio falling in the specified range of Si/Al ratio of the zeolite of which the membrane to be produced, and forming a first synthesis gel that contains the above mentioned precursor medium and zeolite particle of the type similar to that of the membrane to be produced, wherein the amount, in percentage, of zeolite particles in the synthesis gel is such that the composition of the synthesis gel is nearly identical to that of the precursor medium, and forming a second synthesis gel exactly in the same manner as that for the first synthesis gel except that the zeolite particles used for the preparation of the second gel is of the type similar to that to be used for the coating of the first layer, and the amount, in percentage, of the zeolite in the second synthesis gel is similar as that of the zeolite in the first synthesis gel, and comparing the rate of crystallization of the required zeolite of which the membrane to be produced, against time, from the above mentioned two synthesis gel under a certain temperature and pressure. The condition for hydrothermal treatment of membrane synthesis is selected such that the first synthesis gel produces completely crystallized product under the selected condition, and the second synthesis gel produces mainly amorphous product under the selected condition.

In an preferable embodiment of the present invention, there is further provided method for producing zeolite membrane, particularly of the type FAU, with high water flux and separation factor for a water/organic mixture, and therefore, the membrane can be used by itself, or, in combination with other type of membrane or film, for the dehydration separation of water from organic in the vapor or liquid phase. H. Kita et. al. [H. Kita et. al., Separation and Purification Technology, Volume 25, 2001, page 261], describes separation performance of zeolite membrane of the type FAU. The related parts of this literature are incorporated herein by reference.

### INDUSTRIAL UTILITY

The zeolite membrane on a porous substrate according to the present invention, which is manufactured by the method described above in detail may be used for gas-separation process, vapor-separation process, liquid-separation process, catalytic process, catalysis and separation process, etc, with an enhanced flux and high separation capability.

### EXAMPLES

To further illustrate the principles of the present invention, there will be described several examples of the zeolite membranes formed according to the invention, as well as certain examples for comparison. However, it is to be understood that the examples are given for illustrative purpose only, and the invention is not limited thereto, but various modifications and changes may be made in the invention, without departing from the spirit and scope of the invention which are only defined by the annexed claims.

### Example 1

A zeolite membrane was prepared and characterized in the following manner.

Zeolite powder of the type USY and NaY, with the code name of HSZ-360HUA and HSZ-320NAA, respectively, was purchased from TOSHO Chemical Company, Japan, and these powder were ball milled to obtain particles of average size of 1.5 μm or less. The ball-milled materials were dispersed respectively in distilled water to obtain slurries. Slurries of different compositions were made by adjusting the amount, in weight percentage, of the zeolite particles in water. A washed and dried porous alumina substrate tube of 12 mm of outer diameter and 100 mm of length and mean pore diameter of around 0.8 μm in the outside layer of the tube was coated with two layers of zeolite particles using two different zeolite slurries of the designated compositions similar to those as shown in Table 1 and a deposition method as follows.

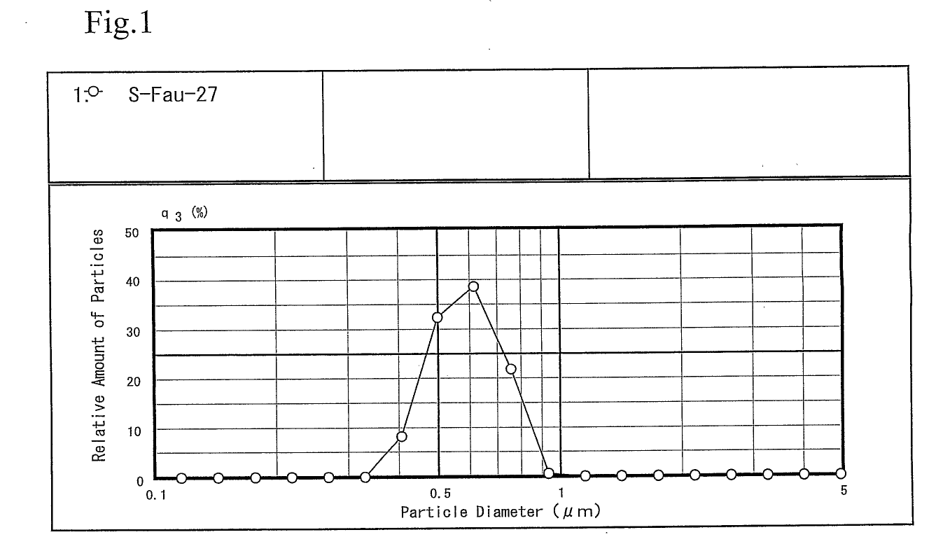

For the coating of the first layer, the alumina substrate tube was dipped, at room temperature (20° C.-30° C.), for 3 minutes, in a slurry of 99.5 wt % water and 0.5 wt % ball-milled USY of particle size distribution similar as that shown in FIG. 1. Thereafter, the substrate was pulled out from the slurry, and thereafter the substrate was dried overnight to obtain USY coated substrate.

The coating of the second layer was carried out on the USY coated substrate tube in the same manner as described for that the coating of the first layer of USY, except that a slurry of 99.7 wt % of water and 0.3 wt % of ball-milled NaY of particle size distribution similar to that shown in FIG. 1, was used for the coating of the second layer to obtain a USY+NaY coated substrate.

TABLE 1

| Coating of the First layer | | | Coating of the Second layer | | |
|---|---|---|---|---|---|
| | Composition of the | | | Composition of the | |
| | slurry | | | slurry | |
| | Amount of | Amount of | | Amount of | Amount of |
| Zeolite | Water in | Zeolite in | Zeolite | Water in | Zeolite |
| type | wt % | wt % | type | wt % | in wt % |
| USY | 99.5 | 0.5 | NaY | 99.7 | 0.3 |

A precursor gel of zeolite was synthesized as follows; 31.16 g of sodium aluminate was added to a sodium hydroxide solution (34.92 g NaOH+172.91 g H₂O) to produce a mixture, and thereafter the mixture was sufficiently stirred at a temperature of 100° C., for 10 minutes to obtain an opaque solution, and thereafter the opaque solution was cooled down to around 17° C., in a water bath. Separately, 400 g of H₂O was added to 120.8 g of water glass (29.09 wt % SiO₂+9.43 wt % Na₂O) and was sufficiently mixed to obtain a transparent solution. Thereafter the opaque solution of sodium aluminate and sodium hydroxide was added to the transparent solution of water glass and the resultant mixture was sufficiently stirred to obtain a precursor gel and the precursor gel was vigorously stirred for 30 minutes. The precursor gel had a molar ratio of 1.0 Al₂O₃:5.04 Na₂O:3.60 SiO₂:234.31 H₂O.

The USY+NaY coated substrate was placed in a vertical position inside a pyrex® type of glass tube of 410 mm of length and 40 mm of inner diameter and 45 mm of outer diameter, and with the help of a Teflon® support rod of 15 mm of length and 8 mm of diameter in a manner, that the USY+NaY coated substrate did not touch the wall of the glass tube, and both the ends of the USY+NaY coated substrate remained open to allow free passage of particles of diameter of as large as 1-2 mm, and a gap of 10 mm between the lower end of the glass tube and the lower end of the USY+NaY coated substrate remained.

Thereafter, 192 g of the precursor gel was poured inside the glass tube slowly along its wall, and the USY+NaY coated substrate remained completely immersed in the precursor gel, and thereafter the hydrothermal crystallization was carried out by placing the glass tube in a preheated oil bath of mean temperature of 102° C., and a condenser fitted at the open end of the glass tube, and cool water of 20° C. was circulated through the condenser to avoid loss of water from the precursor gel during the whole crystallization process.

After hydrothermal treatment for 2 hours 30 minutes, the glass tube was detached from the condenser and taken out from the oil bath, and the substrate part of the product was separated immediately from the gel part of the product, and the substrate part of the product was washed in ample amount of distilled water of 20° C., and was stored in distilled water of 20° C.

The substrate part of the product was characterized for its performance for the pervaporation separation of water and ethanol mixture at 75° C.

Flux and Separation Factor was defined as;

Flux=total amount of permeated liquid in kg per hour (h) per unit area in m² of the substrate part of the product, that was exposed to the water/ethanol mixture.

Separation Factor=wt % of water in the permeate divided by the wt % of water in the feed divided by the wt % of ethanol in the permeate multiplied by the wt % of ethanol in the feed.

After 2 hours and 30 minutes of pervaporation at 75° C., with a feed solution of 9.34 wt % of water in 90.66 wt % of ethanol, a water flux of 7.06 kg/m²/hand a separation factor of 1220 was obtained. The separation results revealed that the substrate part of the product contained a membrane, and the membrane permitted selective permeation of water from a mixture of water and ethanol, and the membrane was highly permeable to water. Hereinafter, the substrate part of the product is referred as a high flux membrane.

The high flux membrane was further subjected to X-ray diffraction analysis and SEM observation of a surface and a cross-section.

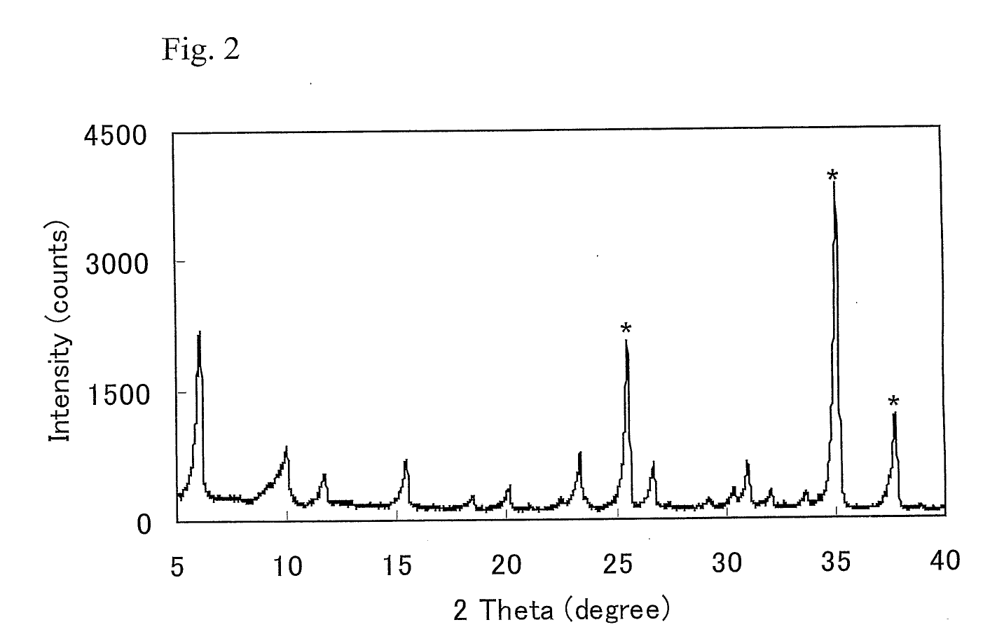

FIG. 2 is an X-ray diffraction pattern of the membrane. X-ray diffraction peaks from alumina substrate were marked with asterisks in FIG. 2. An examination of the pattern revealed that the membrane contained, other than alumina, single and pure phase of zeolite of the type FAU. Hereinafter, the high flux membrane is referred as a FAU membrane.

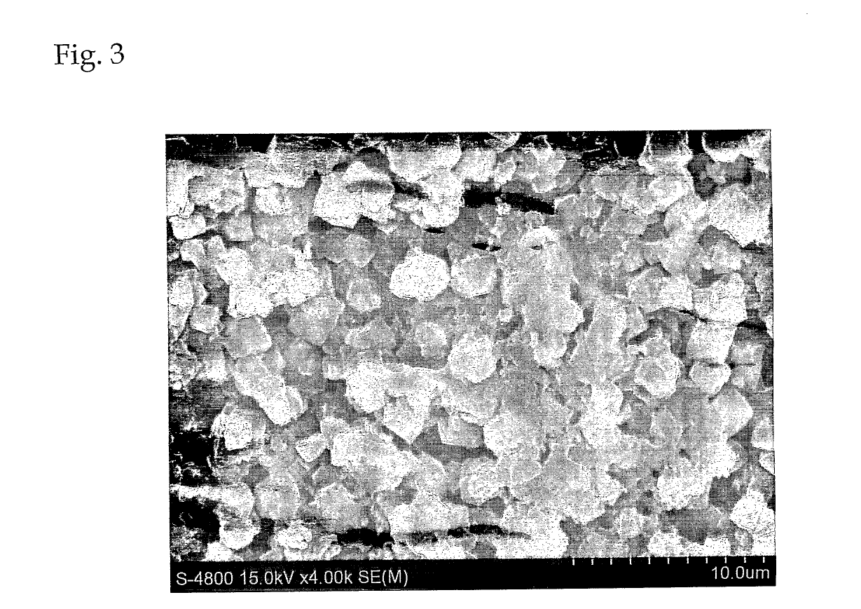

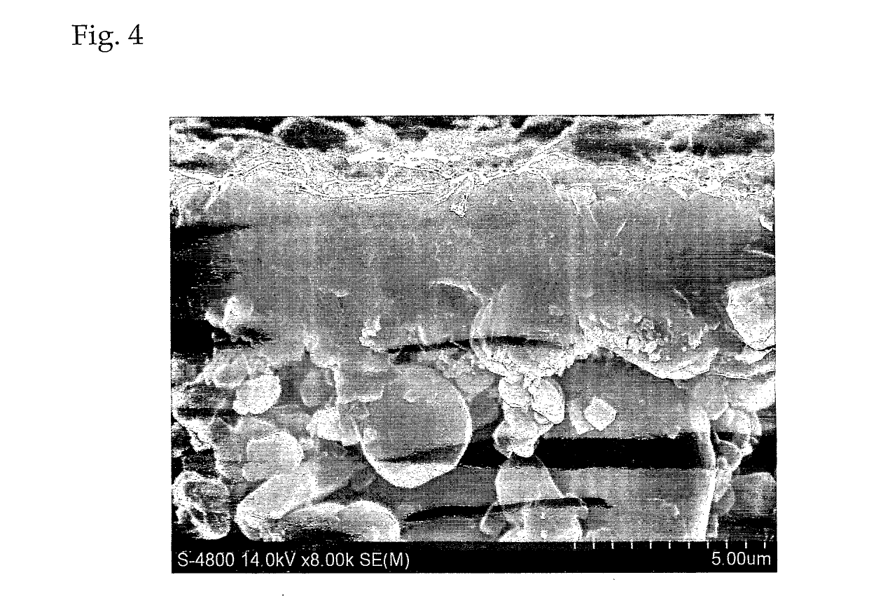

FIG. 3 is a scanning electron micrograph (SEM) taken at a magnification of 4000 times of a surface of the FAU membrane and FIG. 4 is a scanning electron micrograph (SEM) taken at a magnification of 8000 times of a cross section of the FAU membrane.

An examination of the SEM revealed the following: (1) a continuous and compact FAU membrane of 3-4 μm of thickness was formed; (2) pure FAU membrane was bound on the external surface of the alumina substrate; (3) the compact part of the membrane contained negligible amount of alumina particles; and (4) thickness of the zeolite-alumina compact and composite layer was negligible as compared to that of pure FAU layer.

The FAU membrane was further subjected to SEM-EDX analysis for the elemental composition of the membrane and it was confirmed that membrane contained zeolite of type X with Si/Al ratio of around 1.3.

### Comparison Example 1

7.81 g of sodium aluminate was added to a sodium hydroxide solution (8.76 g NaOH+41.46 g H₂O) to produce a mixture, and the mixture was sufficiently stirred at a temperature of 100° C., for 10 minutes to obtain an opaque solution and thereafter the opaque solution was cooled down to around 17° C. in a water bath. 103.67 g of a slurry of 98 wt % water and 2 wt % ball-milled zeolite of the type NaY of particle size distribution similar to that shown in FIG. 1, was added to 31.58 g of water glass (29.09 wt % SiO₂+9.43 wt % Na₂O) and was sufficiently mixed at around 17° C., for 4 minutes to obtain milky mixture. Thereafter, the opaque solution of sodium aluminate and sodium hydroxide was added to the milky mixture of water glass and NaY particles, and the resultant mixture was sufficiently stirred to obtain a synthesis gel, and the synthesis gel contained NaY particles in a precursor gel, and the precursor gel had a molar ratio of 1.0 Al₂O₃:5.04 Na₂O:3.60 SiO₂:234.31 H₂O, and the amount, in gram, of NaY in the synthesis gel was adjusted to half of the amount, in gram, of alumina in the precursor gel. The synthesis gel was vigorously stirred for 30 minutes.

180 g of the synthesis gel was equally divided in three glass tubes of 410 mm of length and 40 mm of inner diameter and 45 mm of outer diameter, and thereafter the hydrothermal treatment was carried out in a preheated oil bath of mean temperature of 102° C., and condensers fitted at the open end of the glass tubes, and cool water of 20° C. was circulated through the condensers to avoid loss of water from the synthesis gel during the hydrothermal treatment. The glass tubes were taken out from the oil bath after selected interval of time same as listed in Table 2.

TABLE 2

| | |
|---|---|
| Tube 1 | 1 hour 30 minutes |
| Tube 2 | 3 hours |
| Tube 3 | 4 hours 30 minutes |

The final products were treated in a manner as described below.

The final product was diluted and cooled with 450 ml of chilled distilled water and the solid product was immediately separated from the transparent liquid part by centrifugation, and the solid product was dried at 50° C., in a vacuum oven for 18 hours. The dried product was crushed into powder, and 270 mg of the powder was thoroughly mixed with 30 mg of Si powder to obtain Si containing product. The three Si containing products were designated as shown in Table 3.

TABLE 3

| | |
|---|---|
| NaY-SiP1 | Si containing product of 1 hour 30 minutes of |
| | hydrothermal treatment |
| NaY-SiP2 | Si containing product of 3 hours of hydrothermal |
| | treatment |
| NaY-SiP3 | Si containing product of 4 hours 30 minutes of |
| | hydrothermal treatment |

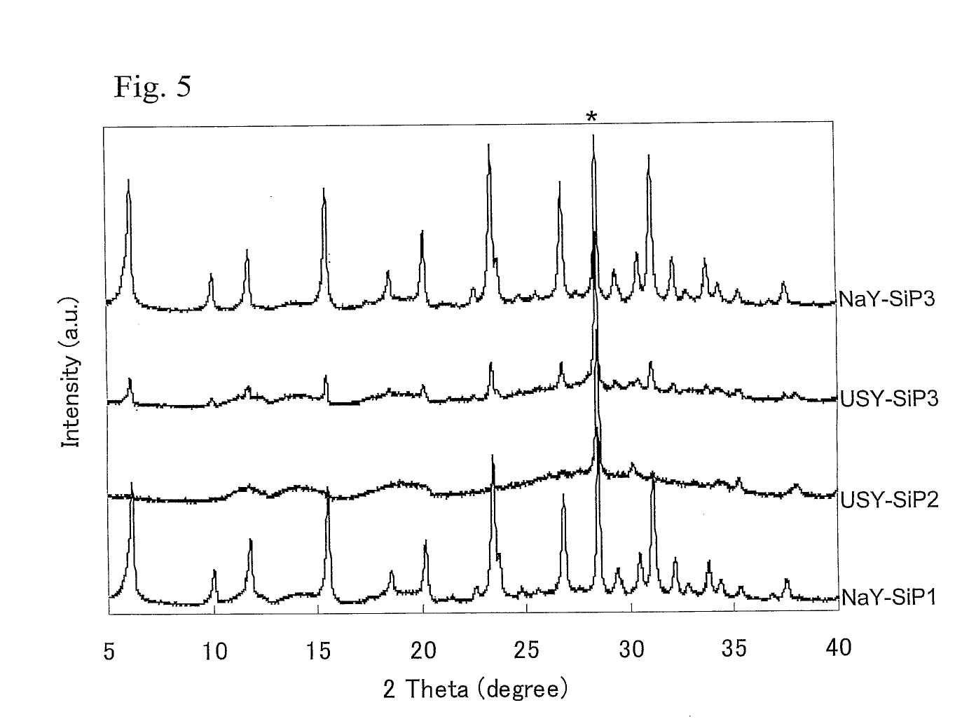

All Si containing products (NaY-SiP1, NaY-SiP2, NaY-SiP3) were subjected to X-ray diffraction analysis. FIG. 5 is a collection of X-ray diffraction patterns of different Si containing products. X-ray diffraction peak from Si powder was marked with asterisk in FIG. 5. An examination of the patterns revealed that highly crystalline pure zeolite of the type FAU was crystallized within 1 hour and 30 minutes of hydrothermal treatment, from NaY containing synthesis gel.

### Comparison Example 2

Synthesis gel was prepared in a similar manner as that in Comparison Example 1 above, except that the ball milled zeolite that was used to prepare the synthesis gel in this example was of type USY. The synthesis gel was hydrothermally treated in a like manner as that for Comparison Example 1 above. The products of hydrothermal treatment were characterized in the same manner as for those in Comparison Example 1 above. Si containing products were designated as shown in Table 4;

TABLE 4

| | |
|---|---|
| USY-SiP1 | Si containing product of 1 hour 30 minutes of |
| | hydrothermal treatment |
| USY-SiP2 | Si containing product of 3 hours of hydrothermal |
| | treatment |
| USY-SiP3 | Si containing product of 4 hours 30 minutes of |
| | hydrothermal treatment |

X-ray diffraction patterns of USY-SiP2 and USY-SiP3 were shown in FIG. 5. An examination of the patterns revealed that USY containing synthesis gel failed to promote crystallization of zeolite of the type FAU even after 3 hours of hydrothermal treatment.

### Example 2

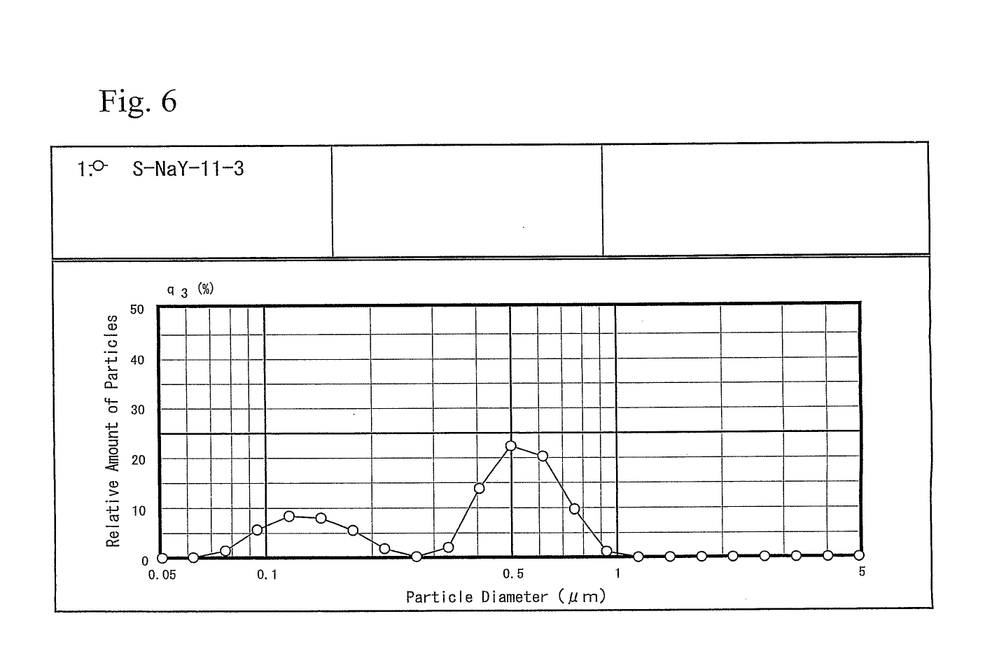

Alumina substrate tube was coated, with two layers of zeolite particles of the designated compositions similar to those shown in Table 5, in the same manner as that the substrate in Example 1 above, except that the slurry used for the coating of the second layer had a bimodal particle size distribution similar to that shown in FIG. 6.

Composition, and the synthesis method of the precursor gel were similar to those in Example 1 above.

The USY+NaY coated substrate was hydrothermally treated in a like manner as for that the USY+NaY coated substrate in Example 1 above.

The substrate part of the product was treated with distilled water and tested for the pervaporation separation of water/ethanol mixture in a manner similar as for that the substrate part of the product in Example 1 above.

After 2 hours and 10 minutes of pervaporation at 75° C., with a feed of 10.02 wt % of water in 89.98 wt % of ethanol, a water flux of 4.95 kg/m²/h and separation factor of 1022, was obtained.

TABLE 5

| Coating of the First layer | | | Coating of the Second layer | | |
|---|---|---|---|---|---|
| | Composition of the | | | Composition of the | |
| | slurry | | | slurry | |
| | Amount of | Amount of | | Amount of | Amount of |
| Zeolite | Water in | Zeolite in | Zeolite | Water in | Zeolite |
| type | wt % | wt % | type | wt % | in wt % |
| USY | 99.8 | 0.2 | NaY | 99.7 | 0.3 |

### Comparison Example 3

Alumina substrate tubes were coated, with a single layer of zeolite particles of type NaY of the designated compositions similar to those shown in Table 6, in the same manner as that the substrate, for the coating of the first layer, in Example 1 above. Composition, and the synthesis method of the precursor gel were similar as those in Example 1 above.

The NaY coated substrates were hydrothermally treated in the precursor gel in a like manner as that in Example 1 above. The substrate part of the product was treated with distilled water and tested for the pervaporation separation of water/ethanol mixture in a manner similar as that in Example 1 above.

Flux, separation factor and feed composition, after 50 minutes of pervaporation of water/ethanol mixture, for each product of the present Example, was listed in Table 6.

For comparison, flux, separation factor and feed composition, after 50 minutes of pervaporation of water/ethanol mixture, for the X type membrane of Example 1 and Example 2, were listed in Table 7.

TABLE 6

| Coating of the First layer | | | Separation performance | | | |
|---|---|---|---|---|---|---|
| | Composition of | | Feed | | | |
| | the slurry | | composition | | | |
| | Amount | Amount | Amount | Amount | | |
| | of | of | of | of | | |
| Zeolite | Water | Zeolite | Ethanol | Water | Flux in | Separation |
| type | in wt % | in wt % | in wt % | in wt % | kg/m²/h | Factor |
| NaY | 99.9 | 0.1 | 89.6 | 10.4 | >50 | <2 |
| NaY | 99.8 | 0.2 | 90.84 | 9.16 | 13.71 | 9 to 11 |
| NaY | 99.7 | 0.3 | 90.39 | 9.61 | 7.04 | 13 to 15 |
| NaY | 99.6 | 0.4 | 90.98 | 9.02 | 11.78 | 9 to 11 |
| NaY | 99.5 | 0.5 | 90.89 | 9.11 | 13.87 | 9 to 11 |

TABLE 7

Separation performance

Feed composition

| | Amount of | Amount of | | |
|---|---|---|---|---|
| | Ethanol in | Water in | Flux in | Separation |
| Membrane | wt % | wt % | kg/m²/h | Factor |
| Example 1 | 90.64 | 9.36 | 7.76 | 825 |
| Example 2 | 89.9 | 10.1 | 6.21 | 580 |

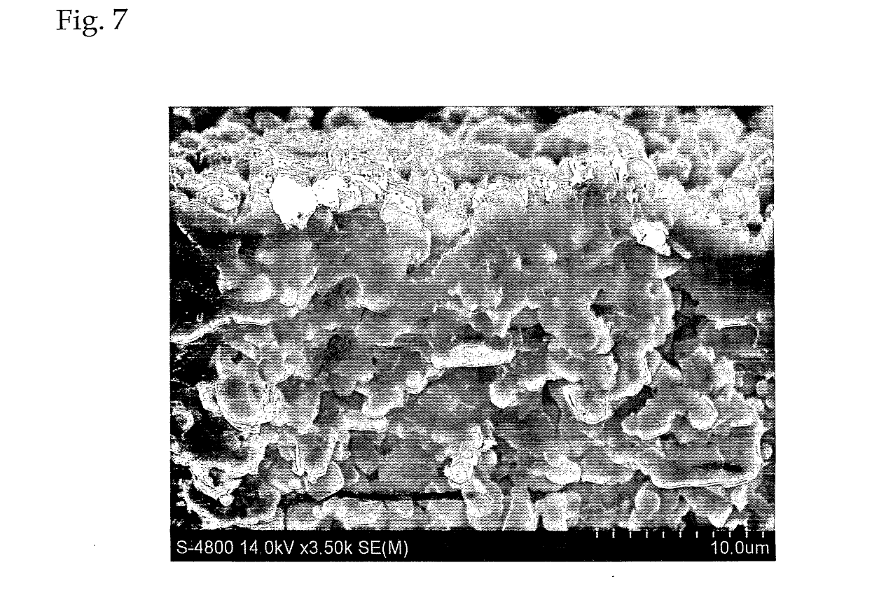

FIG. 7 is a scanning electron micrograph (SEM) taken at a magnification of 3500 times of a cross section of the membrane synthesized in the present example, using a slurry of 0.5 wt % of NaY in 99.5 wt % of water.

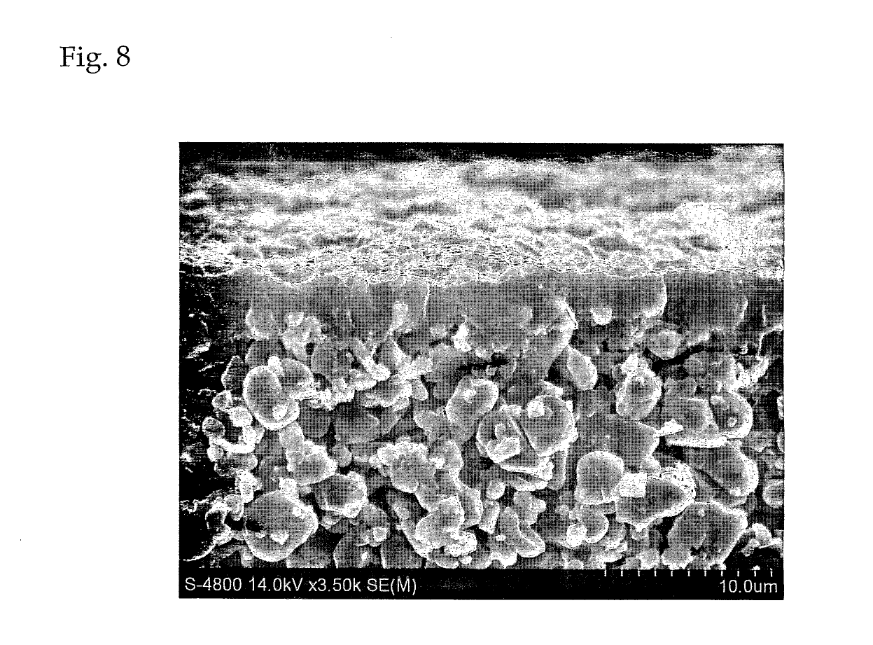

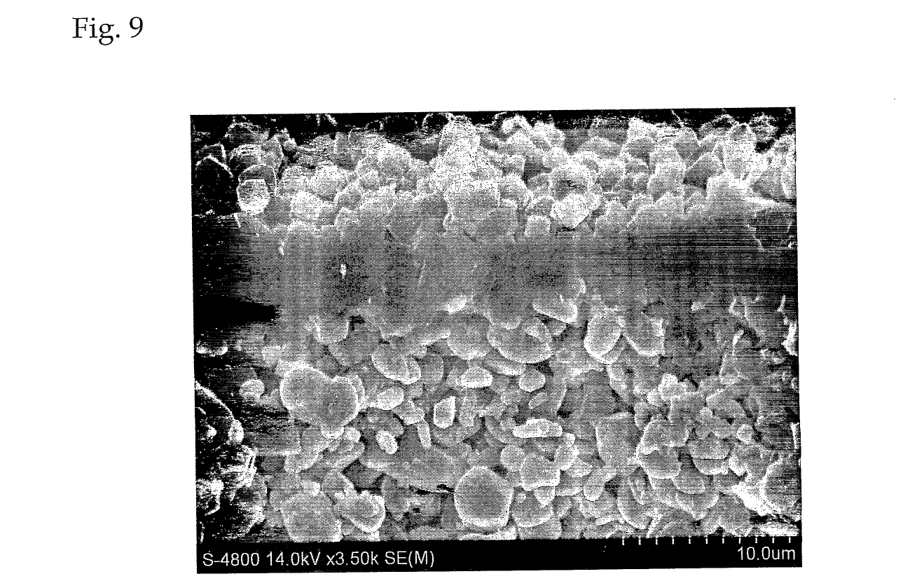

FIG. 8 and FIG. 9 are scanning electron micrographs (SEM) taken at a magnification of 3500 times of cross section of the membrane of Example 1 and Example 2, respectively.

An examination of the SEM revealed the following: (1) considerable amount of FAU crystals were formed inside the alumina layer, or, in other words, formation of zeolite-alumina composite layer was considerably high for the membrane that was synthesized on alumina substrate coated with a single layer of NaY; (2) formation of zeolite-alumina composite layer was negligible when USY was used for the coating of the first layer, followed by the coating of NaY layer; (3) USY was consumed during the hydrothermal treatment to grow the membrane, and, therefore, top layer of the alumina substrate layer remained highly porous after the hydrothermal treatment; and thus, (4) USY acted as a mask and provided precursors for the growth of the membrane while NaY acted as seeds for the faster growth of compact zeolite layer.

### Example 3

Alumina substrate tube was coated, with two layers of zeolite particles of the designated composition similar to that shown in Table 8, in the same manner as that the substrate in Example 1 above. Composition, and the synthesis method of the precursor gel were similar as those in Example 1 above. The USY+NaY coated substrate was hydrothermally treated in the precursor gel in a like manner as that in Example 1 above. The substrate part of the product was treated with distilled water and tested for the pervaporation separation of water/ethanol mixture in a manner similar as that in Example 1 above. After 2 hours and 30 minutes of pervaporation at 75° C., with a feed solution of 10.07 wt % of water in 89.93 wt % of ethanol, a water flux of 8.58 kg/m²/h and a separation factor of 484 was obtained.

TABLE 8

| Coating of the First layer | | | Coating of the Second layer | | |
|---|---|---|---|---|---|
| | Composition of the | | | Composition of the | |
| | slurry | | | slurry | |
| | Amount of | Amount of | | Amount | Amount of |
| Zeolite | Water in | Zeolite in | Zeolite | of Water | Zeolite |
| type | wt % | wt % | type | in wt % | in wt % |
| USY | 99.5 | 0.5 | NaY | 99.8 | 0.2 |

### Example 4

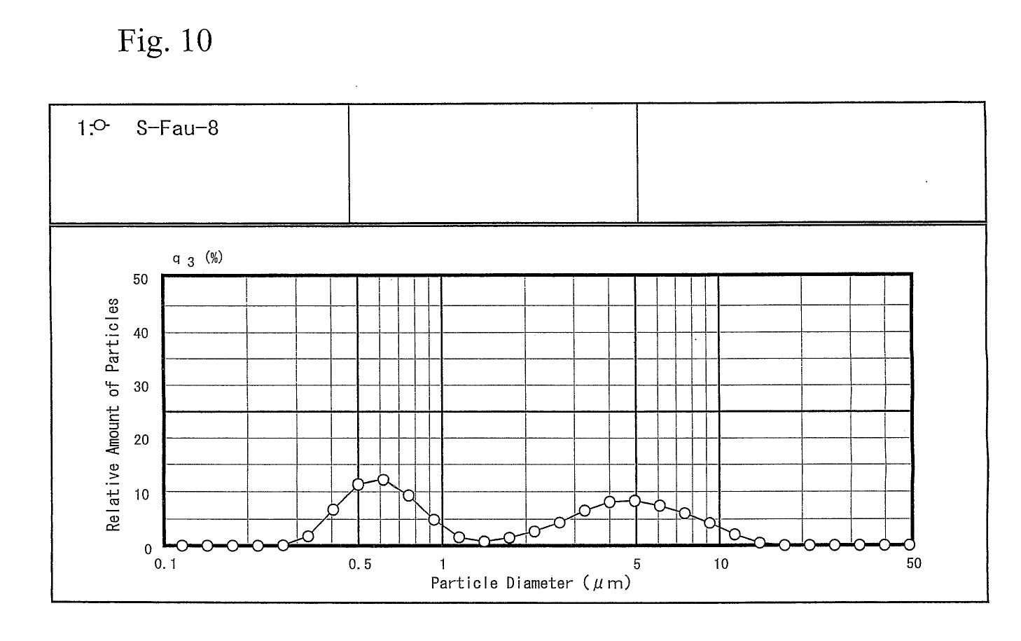

Alumina substrate tube was coated, with two layers of zeolite particles of the designated compositions similar to those shown in Table 1, in the same manner as that the substrate in Example 1 above, except that the slurry used for the coating of the first layer had a bimodal particle size distribution similar to that shown in FIG. 10.

Composition, and the synthesis method of the precursor gel were similar to those in Example 1 above.

The USY+NaY coated substrate was hydrothermally treated in a like manner as for that the USY+NaY coated substrate in Example 1 above.

The substrate part of the product was treated with distilled water and tested for the pervaporation separation of water/ethanol mixture in a manner similar as for that the substrate part of the product in Example 1 above.

After 2 hours and 30 minutes of pervaporation at 75° C., with a feed of 9.49 wt % of water in 90.51 wt % of ethanol, a water flux of 7.45 kg/m²/h and separation factor of 898, was obtained.

### Example 5

Alumina substrate tube was coated with two layers of zeolite particles in the same manner as that in Example 1 above. Composition, and the synthesis method of the precursor gel were similar as those in Example 1 above.

The USY+NaY coated substrate was hydrothermally treated in a like manner as that the USY+NaY coated substrate in Example 1 above, except that the treatment temperature and time were 92° C., and 3 hours 30 minutes, respectively.

The substrate part of the product was treated with distilled water and tested for the pervaporation separation of water/ethanol mixture in like manner as that the substrate part of the product in Example 1 above.

After 2 hours and 30 minutes of pervaporation at 75° C., with a feed of 10.2 wt % of water in 89.8 wt % of ethanol, a water flux of 9.33 kg/m²/h and separation factor of 386, was obtained. The separation results revealed that the substrate part of the product contained high flux membrane. The substrate part of the product was subjected to X-ray diffraction analysis, SEM observation of a surface and a cross-section and SEM-EDX analysis of elemental composition.

The resultant diffraction pattern from X-ray analysis, and the elemental analysis by SEM-EDX analysis, confirmed formation of pure zeolite membrane of type X. Hereinafter, the membrane is referred as a zeolite X membrane.

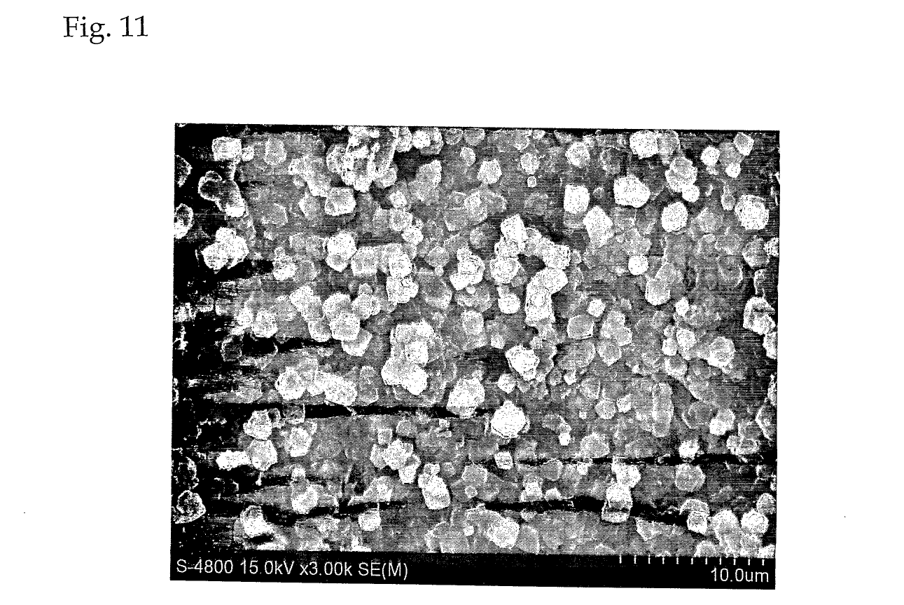

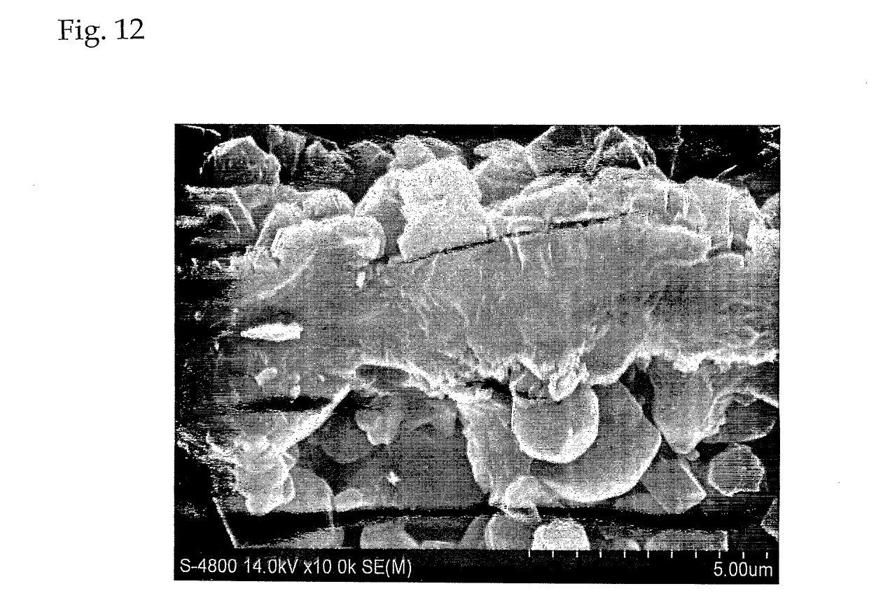

FIG. 11 is a scanning electron micrograph (SEM) taken at a magnification of 3000 times of a surface and FIG. 12 is a scanning electron micrograph (SEM) taken at a magnification of 10000 times of a cross section of the zeolite X membrane.

An examination of the SEM revealed the following: (1) a continuous and compact zeolite X membrane of 2-2.5 μm of thickness was formed; (2) zeolite X membrane was bound on the external surface of the alumina substrate; and (3) thickness of the zeolite-alumina compact and composite layer was negligible as compared to that of the pure zeolite X layer.

### Example 6

Alumina substrate tube was coated with two layers of zeolite particles in the same manner as that the substrate in Example 1.

A precursor gel of zeolite was synthesized as follows; 31.26 g of sodium aluminate was added to a sodium hydroxide solution (2.91 g NaOH+172.91 g H₂O) to produce a mixture, and the mixture was sufficiently stirred at high temperature (100° C.), for 10 minutes to obtain an opaque solution, and thereafter the opaque solution was cooled down to around 27° C., in a water bath. Separately, 240.46 g of H₂O was added to 335.4 g of water glass (29.09 wt % SiO₂+9.43 wt % Na₂O) and was sufficiently mixed at around 27° C., for 4 minutes to obtain a transparent solution. Thereafter, the opaque solution of sodium aluminate and sodium hydroxide was added to the transparent solution of water glass, and 226 g of H₂O was added to the mixture, and the resultant highly viscous mixture was vigorously stirred to obtain a less viscous gel and the gel was stirred vigorously for 3 hours to obtain precursor gel. The precursor gel had a molar ratio of 1.0 Al₂O₃:4.60 Na₂O:9.98 SiO₂:249.83 H₂O.

The USY+NaY coated substrate was hydrothermally treated in a like manner as for that the USY+NaY coated substrate in Example 1 above, except that the treatment time was 5 hours 30 minutes.

The substrate part of the product was treated with distilled water and tested for the pervaporation separation of water/ethanol mixture in a manner similar as for that the substrate part of the product in Example 1.

After 2 hours and 50 minutes of pervaporation at 75° C., with a feed of 10.0 wt % of water in 90 wt % of ethanol, a water flux of 4.04 kg/m²/h and separation factor of 148, was obtained. The separation results revealed that the substrate part of the product contained a membrane.

The substrate part of the product was subjected to X-ray diffraction analysis, SEM observation of a cross-section and SEM-EDX analysis of elemental composition.

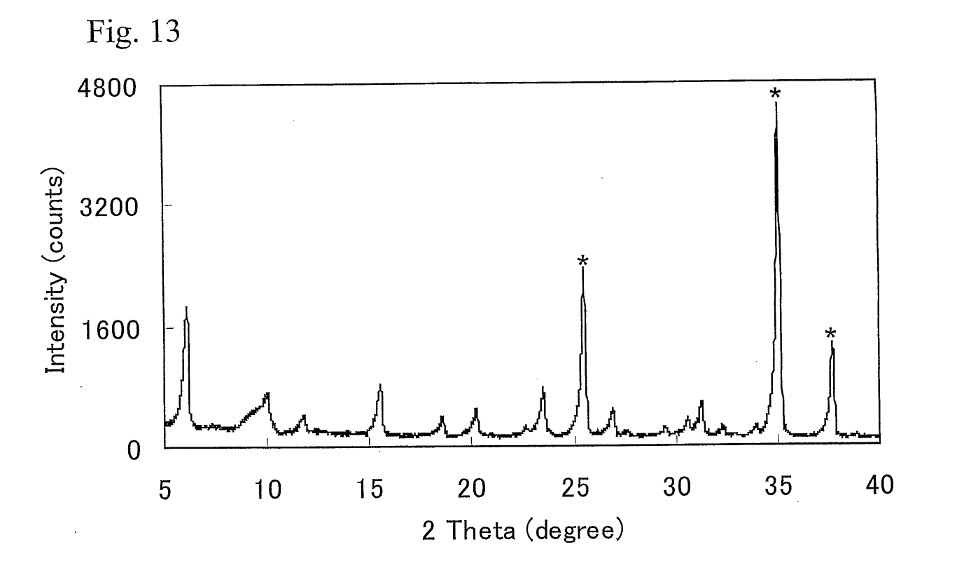

FIG. 13 is an X-ray diffraction pattern of the membrane. An examination of the pattern confirmed that the membrane was of zeolite of type FAU. Hereinafter, the membrane is referred as a FAU membrane.

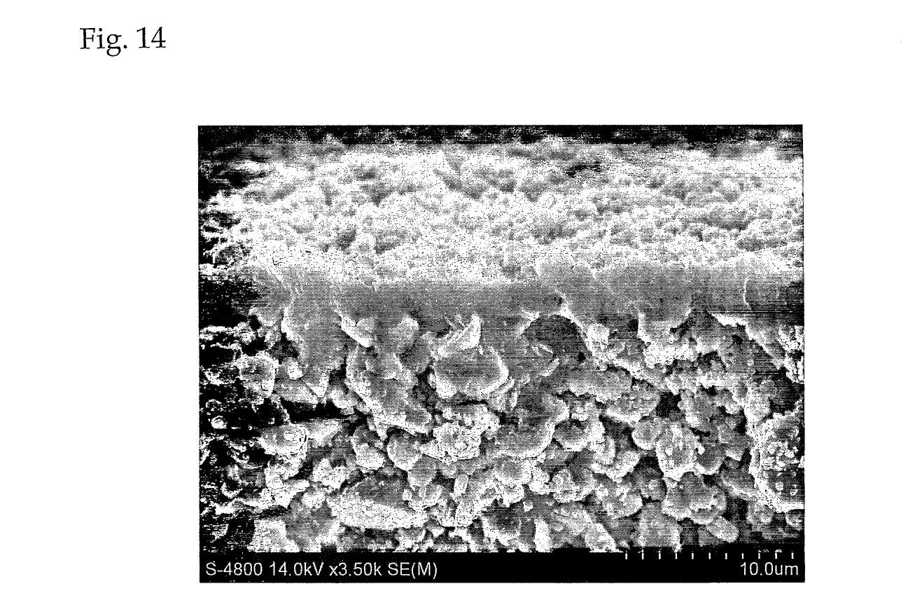

FIG. 14 is a scanning electron micrograph (SEM) taken at a magnification of 3500 times of a cross section of the FAU membrane.

An examination of the SEM revealed the following: (1) a continuous and compact FAU membrane of 3-4 μm of thickness was formed; (2) FAU membrane was formed on the external surface of the alumina substrate; (3) the compact part of the membrane contained negligible amount of alumina particles; and (4) thickness of the zeolite-alumina compact and composite layer was negligible as compared to that of pure FAU layer.

The FAU membrane was further subjected to SEM-EDX analysis for the elemental composition of the membrane and it was confirmed that membrane was of zeolite of the type Y with Si/Al ratio of around 2.3.

### Comparison Example 4

15.63 g of sodium aluminate was added to a sodium hydroxide solution (1.45 g NaOH+30 g H₂O) to give a mixture, and the mixture was sufficiently stirred at high temperature (100° C.), for 10 minutes to give an opaque solution and thereafter the opaque solution was cooled down to around 27° C., in a water bath. 65.47 g slurry of 93.68 wt % water and 6.32 wt % ball-milled zeolite of type NaY of particle size distribution similar to that shown in FIG. 1, and 58.7 g H₂O, was added to 167.7 g of water glass (29.09 wt % SiO₂+9.43 wt % Na₂O) and was sufficiently mixed at around 27° C., for 4 minutes to obtain a milky mixture. Thereafter the opaque solution of sodium aluminate and sodium hydroxide and 110 g of H₂O, was added to the milky mixture of water glass and NaY particles, and the resultant highly viscous mixture was vigorously stirred to obtain a less viscous gel and the less viscous gel was stirred vigorously for 3 hours to obtain a synthesis gel, and the synthesis gel contained NaY particles and precursor gel, and the precursor gel had a molar ratio of 1.0 Al₂O₃:4.60 Na₂O:9.98 SiO₂:249.83 H₂O, and the amount, in gram, of NaY in the synthesis gel was adjusted to half of the amount, of alumina, in the precursor gel. 306 g of the synthesis gel was equally divided in three glass tubes of 410 mm of length and 40 mm of inner diameter and 45 mm of outer diameter, and the hydrothermal treatment was carried out by placing the synthesis gel containing glass tubes in a preheated oil bath of mean temperature of 102° C., and condensers were fitted at the open end of the glass tubes, and cool water of 20° C. was circulated through the condensers to avoid loss of water from the synthesis gel during the whole crystallization process. The glass tubes containing the products were taken out from the oil bath after selected interval of time same as listed in Table 9.

TABLE 9

| | |
|---|---|
| Tube 1 | 1 hour 30 minutes |
| Tube 2 | 2 hours 30 minutes |
| Tube 3 | 3 hours 30 minutes |

The final products from all the three glass tubes were treated as follows.

The final product, in each tube, was diluted and cooled with 450 ml of chilled water and the solid product was immediately separated from completely transparent liquid part by centrifugation, and the solid product was dried at 50° C., in a vacuum oven for 18 hours. The dried product was crushed into powder, and 270 mg of the powder was thoroughly mixed with 30 mg of Si powder to obtain Si containing product. The three Si containing products were designated as shown in Table 10.

TABLE 10

| | |
|---|---|
| NaY-Y-SiP1 | Si containing product from hydrothermal |
| | crystallization of 1 hour 30 minutes |
| NaY-Y-SiP2 | Si containing product from hydrothermal |
| | crystallization of 2 hours 30 minutes |
| NaY-Y-SiP3 | Si containing product from hydrothermal |
| | crystallization of 3 hours 30 minutes |

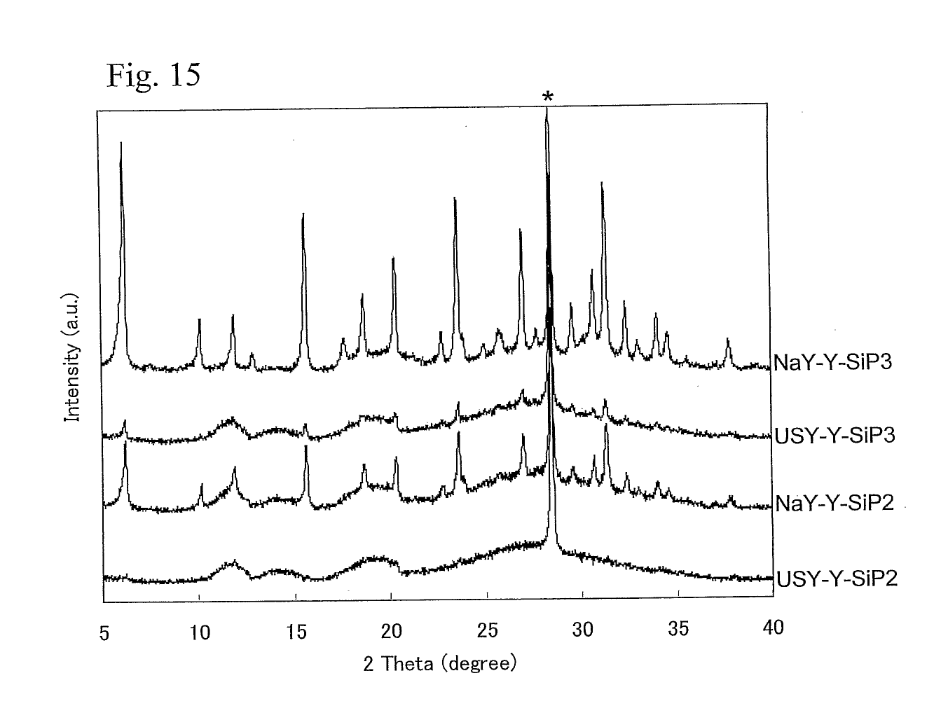

All the Si containing products were subjected to X-ray diffraction analysis. FIG. 15 is a collection of X-ray diffraction patterns of different Si containing products. X-ray diffraction peak from Si powder was marked with asterisk in FIG. 15. An examination of the patterns revealed that highly crystalline pure zeolite of the type FAU was crystallized within 3 hour and 30 minutes of hydrothermal treatment, from NaY containing synthesis gel.

### Comparison Example 5

Synthesis gel was prepared in the same manner as for that in Comparison Example 4, except that the ball milled zeolite that was used to prepare the synthesis gel in this example was of type USY of particle size distribution similar to that shown in FIG. 1. Hydrothermal crystallization of the synthesis was carried out in a like manner as for that in Comparison Example 4.

Characterization of products of the hydrothermal crystallization was carried out in the same manner as for that in Comparison Example 4. Si containing products were designated as shown in Table 11;

TABLE 11

| | |
|---|---|
| USY-Y-SiP1 | Si containing product from hydrothermal |
| | crystallization of 1 hour 30 minutes |
| USY-Y-SiP2 | Si containing product from hydrothermal |
| | crystallization of 2 hours 30 minutes |
| USY-Y-SiP3 | Si containing product from hydrothermal |
| | crystallization of 3 hours 30 minutes |

X-ray diffraction patterns of USY-Y-SiP2 and USY-Y-SiP3 were shown in FIG. 15. An examination of the patterns revealed that USY containing synthesis gel failed to promote crystallization of zeolite of the type FAU even after 3 hours 30 minutes of hydrothermal treatment.

### Example 7

Alumina substrate tube was coated with two layers of zeolite particles in the same manner as that in Example 1 above. Composition, and the synthesis method of the precursor gel were similar as those in Example 6 above.

The USY+NaY coated substrate was hydrothermally treated in a like manner as that the USY+NaY coated substrate in Example 6 above, except that the treatment temperature was 98° C., for the present example. The substrate part of the product was treated with distilled water and tested for the pervaporation separation of water/ethanol mixture in like manner as that the substrate part of the product in Example 6 above.

After 2 hours and 50 minutes of pervaporation at 75° C., with a feed of 10.09 wt % of water in 89.91 wt % of ethanol, a water flux of 6.21 kg/m²/h and separation factor of 190, was obtained. The separation results revealed that the substrate part of the product contained high flux membrane.

### Comparison Example 6

Alumina substrate tube was coated, with two layers of zeolite particles of the designated compositions similar to those shown in Table 1, in the same manner as that the substrate in Example 7 above, except that the slurry used for the coating of the first layer, in the present example, was of type NaY with particle size distribution similar to that shown in FIG. 1.

Composition, and the synthesis method of the precursor gel were similar to that in Example 7 above.

The NaY coated substrate was hydrothermally treated in a like manner as for that the USY+NaY coated substrate in Example 7 above.

The substrate part of the product was treated with distilled water and tested for the pervaporation separation of water/ethanol mixture in a manner similar as for that substrate part of the product in Example 7 above.

The pervaporation experiment revealed that the substrate part of the product was highly permeable to both water and ethanol (Flux>100 kg/m²/h), and therefore no separation of water and ethanol was obtained, and therefore no membrane could be obtained in the present example.

1. A method for the production of crystalline zeolite membrane on a porous substrate, which comprises coating the surface of the porous substrate with a first powder, coating the first powder-coated surface of the porous substrate with a second powder, and contacting the first powder- and second powder-coated porous substrate with a precursor medium for the crystalline zeolite in order to carry out hydrothermal synthesis of the zeolite, wherein the first powder is a powder which renders substantially no aid to the growth of the crystalline zeolite membrane, and wherein the second powder is a crystalline zeolite powder which promotes the growth of the crystalline zeolite membrane.

2. The method according to claim 1, wherein the first powder is a crystalline zeolite powder which renders substantially no aid to the growth of the crystalline zeolite membrane.

3. The method according to claim 1, wherein the crystalline zeolite membrane to be manufactured is a member selected from the group consisting of FAU, ZSM-5, BEA, LTA, LTL, KFI, RHO, MOR and FER.

4. The method according to one of claims 1-3, wherein the crystalline zeolite powder as the second powder has a similar framework type to that of the crystalline zeolite membrane to be manufactured.

5. The method according to one of claims 1-4, wherein the first powder is USY, and the second powder is NaY, when the crystalline zeolite membrane is of X or Y type FAU.
